(19) United States
(12) Patent Application Publication
(10) Pub. No.: US 2017/0332827 A1
(43) Pub. Date: Nov. 23, 2017

(54) BEVERAGE CAPSULE, BEVERAGE PREPARATION SYSTEM AND METHOD FOR IDENTIFYING A BEVERAGE CAPSULE

(71) Applicant: Qbo Coffee GmbH, Wallisellen (CH)

(72) Inventor: Ivo Aschwanden, Zürich (CH)

(21) Appl. No.: 15/534,095

(22) PCT Filed: Dec. 8, 2015
(86) PCT No.: PCT/EP2015/078938

§ 371 Date: Jun. 8, 2017

(30) Foreign Application Priority Data
Dec. 11, 2014 (EP) 14197487.3

(51) Int. Cl. A47J 31/36; A47J 31/40; G06T 7/73; G06K 9/58; B65D 85/804

(52) U.S. Cl. CPC A47J 31/3623; G06K 9/58; B65D 85/8043; G06T 7/74; A47J 31/3695; A47J 31/3676; A47J 31/407

(57) ABSTRACT

A capsule for beverage preparations in a brewing machine, the capsule including a capsule container that is filled with an extraction product and has an essentially quadratic base, and a capsule cover that closes the capsule container. The capsule has at least one first optically readable code on the base of the capsule container, the code having a two-dimensional arrangement of several first code elements, which respectively contain information from which one of several possible orientations of the code on the plane of the base can be derived in a unique manner. The invention also relates to a capsule and to an associated system including a brewing machine and to a method for identifying the type of capsule.

### FIELD OF THE INVENTION

The present invention relates to a drinks (beverage) capsule for creating a drink (beverage) from a drinks ingredient contained in the capsule. In particular, it relates to a drinks capsule which includes a code that is able to contain information on the drinks ingredient contained in the capsule or on other characteristics of the capsule, and able to be decoded by a brewing machine. The invention moreover relates to a drinks (beverage) preparation system including a drinks capsule and a brewing machine, and to a method for identifying a drinks capsule in a brewing machine.

### DESCRIPTION OF RELATED ART

Specifically, the present invention relates to a capsule for drinks preparation in a brewing machine, the capsule including a capsule beaker filled with a drinks ingredient and having an essentially square base, and a capsule cover, which is fastened on the capsule beaker. The capsule as a whole is thereby preferably essentially cubic, i.e. the lateral walls of the capsule, which connect the base and the cover, have essentially the same square shape as the base and the cover. The lateral edge length however can also be larger or smaller, so that an essentially cuboid capsule then arises.

Capsules of this type are known from EP 2419352 A1, WO 2015/096989, WO 2105/096990 and WO 2015/096991, which are referred to here.

Individual portion capsules for preparing drinks, in particular hot drinks (beverages) such as coffee, tea, chocolate drinks or milks drinks are enjoying increasing popularity. Such drinks capsules typically include an extraction material, such as roasted or ground coffee or tea for example, or one or more soluble drinks ingredients such as instant coffee, milk powder or cocoa powder. Apart from these known ingredients, the term “extraction material” within the scope of the present invention is also to include a cleaning agent, which can be utilised for cleaning a brewing machine.

It is already known to provide drinks capsules with a code, which can be read out by the brewing machine and which, for example, contains information on the capsule type, on the drinks ingredient or on the optimal brewing parameters for the capsule concerned. Capsules, on which a bar code is deposited on a cover membrane, amongst others are known, for example, from EP 2168073, and capsules, on which a QR-code is printed, likewise on a cover membrane, are known from WO 2011/089048A1, for example.

It is indeed relatively simple to deposit a code on a cover membrane, which is to say on a capsule cover. The covers are often printed in any case and can be provided with a code with only little additional effort. However, the reading-out of the code on the cover is difficult, particularly given a horizontal arrangement of the capsule in a brewing machine, with which the water is mostly introduced through the capsule base and the brewed product exits through the cover membrane, which is to say through the cover, and is led into the cup. A detection unit which is provided in the brewing chamber at the side of the capsule cover is therefore always exposed to a contamination by way of drinks residues, splashes, etc. Moreover, one typically wishes to keep the path between the exit of the drink out of the capsule and the cup as short as possible, and for this reason it is quite a challenge to be able to accommodate the detection unit at all. The solutions which are described in EP 2168073 and in WO 2011/089048A1 are therefore not suitable for capsules which are brewed in so-called horizontal brewing machines, i.e. in a horizontal alignment.

Further disadvantages of the state of the art lie in the applied codes themselves. The quantity and type of information that can be coded into a bar code is very limited.

QR-codes and similar, known 2-D codes, although being able to contain and code very much more information, however due to their structure are only suitable for the application on drinks capsules to a limited extent if these are to be read out in brewing machines. A common problem on reading out a code provided on a capsule in a brewing machine, are specifically the contaminations, which arise due to splashing of drinks, lime deposits and the like, and such contamination can occur on the read-out optics, as well as on the capsule itself, depending on the mounting of the capsules.

Common, optical 2-D codes include all so-called finder patterns, whose successful recognition is absolutely necessary in order to be able to read out the code. If a local contamination is now located right in the region of the finder pattern, then the complete code becomes unreadable. The robustness cannot therefore be infinitely increased by way of increasing the redundancy. Finder patterns limit the maximum robustness that can be achieved. This then leads to an error notice, depending on the programming of the machine, and this demands a removal of the non-readable capsule. If such a problem cannot be overcome by way of cleaning the read-out optics or the capsule, then the capsule—which per se is consumable—must possibly even be thrown away, which is of course unacceptable from the customer's point of view. The demands upon the optics of the camera and on the computation capability of the processor of the detection unit in a brewing machine are difficult to meet with an acceptable effort with regard to cost and space in the case of the known 2-D codes.

### SUMMARY OF THE INVENTION

It is therefore an object of the present invention, to provide a capsule of the initially mentioned type, which is provided with a code, the code being able to store a sufficient quantity of information and being able to be read out in the brewing machine in a rapid manner and with an extremely high success rate. It is further an object of the invention, to provide a system of such a capsule and of a brewing machine, as well as a method for the identification of such a capsule, which overcome the mentioned disadvantages.

According to the invention, at least one first optically readable code is provided on the base of the capsule, consequently of the capsule beaker, which is to say present on the base. The first code has a two-dimensional arrangement of several first code elements, which each include information, from which one of several possible alignments of the code in the plane of the base can be unambiguously derived. The code elements themselves typically have a two-dimensional design and have such a geometric contour to permit the alignment or orientation of the code elements in the plane of the base to be determined. The alignment of individual first code elements hereby correlates to the alignment of the first code formed by the code elements. One of several possible alignments of the code can be determined in a reliable and unambiguous manner on the basis of a determining of the orientation of an arbitrary code element, due to the fact that preferably each code element has a defined alignment to the alignment of the code. The information concerning the orientation of the code in particular can be contained in each code element, so that it is at least the alignment of the code, which can be recognised without further ado, independently of the actual reading-out and decoding of the code.

Apart from the alignment, the position as well as the size, the horizontal and vertical scaling of the code, or the position as well as the size, the horizontal and vertical scaling of a grid or raster forming the basis of the code can also be coded in the code elements themselves.

Attaching the code on the base of the capsule, and not on a cover, or, as described in the state of the art cited above, on a cover membrane, has various advantages. The capsule cover is therefore available for a decorative print, for information that can be read by the user, or the like, and the fashioning of the cover is not compromised by an additional code. However, supplementarily or alternatively to a printing of the capsule cover, one also does not rule out the base of the capsule beaker including further visually recognisable elements additionally to the code, for example decorative elements, a identifier or other information in a suitable form, which can be read out. In particular, the code can also be suitably integrated into a for example decorative element.

Moreover, due to the incorporation of the code on the base, a detection unit in a horizontal brewing machine can be arranged ahead of the brewing chamber, i.e. upstream of the brewing chamber, where there is less danger of contamination due to the splashing of drinks or the like and the installation space is less critical.

The capsule of the known type can be inserted or introduced into the brewing machine in four different positions due to its symmetry and its square cross section. There are therefore four orientations for the capsule, each rotated by 90° and thus also for the code, which is present on the base of the capsule. One of several possible orientations of the code can be unambiguously determined already by way of the recognition and identification of an individual and arbitrary code element, due to the fact that the individual code elements carry information concerning the orientation of the code. The orientation of the code can therefore be determined in a robust manner via a majority decision on the basis of all determined orientations of the code elements. If the arrangement of the code elements is selected in a manner such that they are located on an imagined grid structure forming the basis of the code, then the grid parameters can moreover be reconstructed by means of an arbitrary selection of code elements. The use of so-called finder patterns for a 2D code thus not only becomes superfluous, but moreover all the disadvantages, which are described above and which arise from a dirtied (contaminated) finder pattern, are advantageously avoided.

The use of finder patterns can be completely done away with due to the fact that the code elements provide coded information by way of their shape, their alignment in the plane and their surfaced distribution in the plane. The robustness of the code, in particular with regard to local contamination can be improved inasmuch as this is concerned.

With regard to the code elements, it is particularly the case that they do not have or define a rotationally symmetrical geometric structure, but rather an unambiguous, in each case imagined pointer structure which is unambiguous, at least for the several possible alignments of the code in the brewing machine, i.e. for different alignments in the plane of the base.

The information for the code orientation and which is required for a decoding and reading-out of the code can be decoupled from the decoding of the code and be determined independently of this, due to the coupling of the code alignment with the alignment of its individual code elements, which is envisaged here. This can have an advantageous effect on the realisation of as low and as inexpensive as possible technical demands on an optical detection unit and on a subsequently connected picture evaluation.

The determining of one of several possible alignments of the code relative to a detection unit of the brewing machine can be effected on the basis of at least one code elements and its alignment in the plane of the base or its alignment in a picture plane of a detection unit. The determining of the alignment of the code is thus independent of the arrangement of several code elements relative to one another.

In particular, the alignment of the code in the plane of the base is contained in each code element, so that the information concerning the alignment and orientation of the capsule relative to the detection unit of the brewing machine is redundantly contained in the code. This also applies to the grid parameters forming the basis of the code. These are also redundantly coded over the complete surface.

According to a further embodiment of the capsule, the first code includes a number of essentially identical and essentially identically aligned first code elements. In particular, it is conceivable for the first code to consist exclusively of identical code elements. Moreover, it is conceivable for the first code to consist of identical code elements which are moreover also aligned identically to one another. Code information in particular can be contained in the spatial and two-dimensional, distributed arrangement of individual code elements. The provision of identical as well as identically aligned first code elements is not only advantageous for the unambiguous determining of the alignment of the code in the plane of the base, as has already been described, but also for an as precise and error-free as possible optical reading-out of the code itself

As an alternative to the embodiment of the code with identical and identically aligned code elements, one can also envisage the code elements not being identical, by way of them systematically or non-systematically differing from one another in a characteristic. It is also possible for the code, additionally to the plurality of code elements including information, from which the alignment of the code in the plane of the base can be unambiguously derived, to include further code elements with which this is not the case.

The detection unit of the brewing machine in particular is provided with an imaging, two-dimensional detector, for example with a camera. The use of exclusively identical and identically aligned first code elements permits the realisation of a particularly inexpensive detection unit. Under certain circumstances, it is only a regionally focused and precise imaging of the code, for example of a central region of the two-dimensional code, which is necessary for a reading-out and decoding of the code. Inasmuch as this is concerned, it can already be sufficient for outer-lying edge regions of the code to be detected or imaged in the detection unit with a reduced focusing/sharpness than the middle region of the code, for reading out and decoding the code. This robustness with regard to blurring or optical errors on reading out, which is entailed by the inventive design of the code, also effects a robustness with regard to variations of the code elements amongst one another. The code elements in particular can differ for one another in their size, colouring, etc.

Since it is only the position of individual code elements within the plane of the base or within edge regions of the code which is decisive for extracting code information, code elements imaged on the detection unit only in a comparatively unfocused manner can already be sufficient for an error-free detection, reading-out and/or decoding of the code.

According to a further embodiment, the first code elements include at least two straight line sections, which are adjacent to one another at a defined angle. Straight-lined line sections of the code elements can be detected particularly precisely and simply in the detection unit. The detection unit in particular includes a two-dimensional, regular arrangement of several optical or light-sensitive (sensitive to the visible, infrared and/or ultraviolet part of the electromagnetic spectrum) sensors, which are typically to be indicted as detector pixels.

Line sections of the code elements, which run in a straight line, can be imaged in accordance with the geometrical arrangement of adjacent detector pixels of the detection unit in this way and manner. In this way and manner, even with a low number of detector pixels, consequently by way of a detection unit having only a comparatively low resolution, it is at least the alignment of the line sections of the code elements, which can be precisely detected for the purpose of determining their alignment, but the position of individual code elements within the 2-D code can also be precisely detected.

According to a further development of this, one further envisages at least one line section of the first code elements running essentially parallel to the outer edges of the essentially rectangular or square code. The outer edges of the code can, but do not necessarily need to be designed in a manner in which they are optically or visually recognisable on the base of the capsule beaker. Moreover, it is conceivable for individual, outer-lying code elements to quasi virtually mark the outer edges of the rectangular or square code solely by way of their edge position. The parallel alignment at least of a line section to the outer edges of the code leads to a clearly recognisable code structure. In particular, possible, slight deviations from the several possible alignments of the code or capsule, which are defined by the brewing machine and which lie within a certain tolerance region, can be recognised by way of visually or optically recognisable outer edges and can be used for the numeric compensation of errors or for picture evaluation.

A parallel alignment of line sections or of code elements relative to the edge of the code is not absolutely necessary for the recognition of the code structure. The code structure can also be contained exclusively in the position of the code elements. Arbitrary, orientatable code elements, which can also be different in shape and size, can be used.

According to a further embodiment, at least one line section of the first code elements runs essentially parallel to the outer edges of the square base. Thereby, in particular one envisages the outer edges of the code also running parallel to the outer edges of the square base. One can moreover envisage the possible alignments of the code in the plane of the base and/or the typically four conceivable alignments of the capsule in the brewing machine coinciding with vertically or horizontally running outer edges of the square base, which is to say horizontally or vertically running outer edges of the rectangular or square code. The detection unit and the picture evaluation, which is integrated into this or subsequently connected to this, inasmuch as this is concerned, can be provided with one or two preferential directions (x, y), which run parallel to the outer edges of the square base, which is to say parallel to the outer edges of the rectangular or square code provided on the base.

Moreover, it is conceivable for at least the first code elements to consist exclusively of line sections, which all run parallel to the outer edges of the code.

According to a further embodiment, the first code elements are designed in an essentially L-shaped manner. An L-shaped design of code elements includes two line sections, which are adjacent to one another roughly at an right angle and which are both designed in a straight-lined manner and can have essentially the same or different lengths. One end of a first line section is hereby adjacent to an end of the second line section. Oppositely lying ends of the line sections are thereby distanced to one another. The intersection point of the line sections can, for example, define a reference point of the respective code element, whereas one of the two line sections can function as a pointer structure. Hereby, it is conceivable for the line sections to have the same or different lengths. A straight-lined pointer, departing from the intersection point of the two line sections, for example can coincide with one of the line sections of the code element and in this way and manner unambiguously determine the alignment of the respective code element and with this, of the complete code, in the plane of the base. An unambiguous orientation of the respective code element can be derived from the relative position and alignment of the two line sections to one another in the case of line sections which are designed roughly equally long.

According to a further embodiment, which is an alternative to this, it is moreover conceivable for the first code elements to include at least one arch section. A multitude of different code elements can be considered, apart from L-shaped code elements. Code elements with at least one arch section, for example, can have a C-shaped or U-shaped geometry. Apart from L-shaped code elements, it is particularly T-shaped or V-shaped code elements that are also conceivable, and these are characterised by a particularly simple geometric structure, so that the determining of an alignment of individual code elements can be effected in a reliable and precise manner, even with the use of a detection unit with a low resolution.

It is particularly those code elements, which consist exclusively of line sections running parallel to the code edges which permit an extensive reduction of the demanded resolution of a detection unit. In particular, an L-shaped code element is characterised by a minimal number of pixels for a detection. An L-shaped code element moreover displays a good behaviour with respect to blurring, on picture recognition and evaluation.

According to a further embodiment, the code elements are lasered onto the base of the capsule beaker or lasered into the base. The deposition of the code elements, consequently of the complete code onto the outer side of the base or into the material of the base is effected by way of laser radiation. Hereby, in particular one can envisage the material of the base undergoing a colour change or texture change when being subjected to laser radiation at a certain defined wavelength region, so that the code elements which are formed by way of this can be visually represented in a particularly high-contrast manner. Thereby, it does not necessarily need to be the case of a colour change that is visible to the human eye. It is also conceivable for a change in the reflection characteristics and/or absorption characteristics concerning IR or UV radiation to be achieved by the laser, so that a code, which cannot be recognised by the naked eye, but by a detection unit using IR-light or UV-light, arises. It is further conceivable for the code elements to be realised as laser engraving on or in the base of the capsule beaker. For this reason, no printing methods or the use of print dyes, which such a method entails are necessary for the attachment of the code elements and of the code, on the base of the capsule beaker. Hence it is also not possible for print dyes, which are printed on or deposited in another manner, to be released during the brewing procedure and being able to get into the drink in the worst case. The lasering of the code elements onto or into the base of the capsule beaker effects a particularly durable and robust coding of the capsule beaker and thus of the complete capsule.

According to a further embodiment, one envisages the first code including 50 to 400 individual code elements and preferably 70 to 100 individual code elements, wherein these code elements are arranged two-dimensionally and spatially distributed on the base of the capsule beaker. The individual code elements in particular are arranged to one another without any overlapping. Inasmuch as this is concerned, they are provided on the base of the capsule beaker in manner distanced to one another. In total 100 to 800 bits of information can be integrated into the base of the capsule beaker by way of the mentioned number of code elements. Hereby, in particular, one envisages a code element each having an information content of 2 bits. In particular, the information content of each and every code element is contained in the relative spatial position of the code element with respect to the remaining code elements in the plane of the base.

A part of the code elements can serve for the implementation of test bits, whereas another part of the code elements contains so-called information bits. A error-free reading-out and decoding or testing of the code is possible by way of the test bits, whereas the information bits are the actual carriers of the code information.

According to a further embodiment, one moreover envisages the first code being subdivided into a regular imagined arrangement of code fields, which are grouped together at least in pairs into code groups. Thereby, within a code group, only a single code field is provided with a code element, whereas the remaining code fields of a code group remain free. If, for example, a code group consist of four code fields, which are adjacent to one another, then four possible spaces are available for the code element. Such a code element can thus represent numbers from 1 to 4, consequently an information content of 2 bits. A code group in particular can include a two-dimensional arrangement of several code fields, which are adjacent to one another. It is conceivable, for example, for a code group to consist of four code fields arranged in a square. However, other two-dimensional constellations, for example such as a rectangular code group, which, for example, consists of two horizontal rows each with three code fields are also conceivable.

According to a further embodiment of this, the local position of a code element within the code group includes information. The total information content of a code group is directly dependent on the number of code elements belonging to the code group. If the code group includes four individual code fields, for example, then each code field per definition can represent a single piece of information, for example a number “0, 1, 2, 3 . . . ”. It is that code field and the value assigned to it, which are selected by way of positioning a code element in a single code field of a code group.

The regular subdivision of the code into code fields and the occupancy of a code group formed from code fields, in each case by only a single code element lead to the respective code, with regard to the subdivision into code groups, having a homogeneous density of code elements over the surface of the code. Inasmuch this is concerned, the presence of a homogeneous information density can represent a plausibility or test criterion already on the picture level of the code, by way of which criterion read errors are recognised, the errors, e.g., being able to be caused by way of contamination and can be erroneously interpreted by the detection unit and/or a subsequently connected control as code elements. The position of individual or several code elements amongst one another can also represent a test criterion or plausibility criterion in the same way and manner.

According to a further embodiment, several code groups and/or code fields are brought together into a code word. The number of code groups and code fields in a code word can be selected in an arbitrary manner. Typically, each code word has an identical number of code elements or an identical number of code groups. For the division into code words, one can envisage each code word consisting of an integer number of code groups. Moreover, it is conceivable for a code word to include for example one or more code groups as well as individual code fields. In particular, a code word can have an odd multiple of code fields.

In particular, several plausibility and/or quality tests can be implemented on different code levels. It is conceivable for a first test to be effected with regard to a defined geometric shape of individual code elements. If, for example, a code element having a geometric structure differing from a predefined, for example L-shaped geometry is read out, then already this can led to a rejection or a correct recognition of the code.

The implementation of a further test criterion or quality criterion is also possible on a further, for example second code level. For example here, on the picture level, one can directly examine whether an envisaged number of code elements is located within a predefined surface segment of the plane. Thus, e.g., an integrity test can be carried out at the level of each or individual code groups or code fields. E.g., one can examine whether a code group includes precisely one code element in each case. The test criterion is not fulfilled if several or less than one code element is present per code group. To the same extent, this can then serve for the correct recognition of the code or one which is to be corrected.

Finally, it is also conceivable to also carry out a plausibility test on the level of individual or several code words. Thus, in particular individual test bits contained in code words can be selectively read and evaluated for the plausibility control. A complete decoding of the code is not necessary for all plausibility or quality tests which have been described above.

Basically, only a certain share of code fields, code groups or code words needs to be able to be read out for a decoding. The plausibility tests and quality assessments of code elements, code fields, code groups and code words can then be used in order to make a good selection, and the reliability of the available information can be included in the decoding process when decoding. In particular, all decoding possibilities resulting in a given situation can be compared to one another. A decision concerning the coded content can then be made with a certain probability or trustworthiness by way of the quality assessment of the respectively determined decoding possibilities.

Moreover, the quality of the code, i.e. its recognisability can be determined several times and thus to a quite reliable extent due to the possibility of a code testing or quality determining on the level of the code elements, on the level of the code fields or code groups and/or on the level of the code words. In particular, the quality of the code recognition can be assessed on each of these levels.

Independently of this, it is generally conceivable for an assessment of the quality of recorded codes on the picture level to be included in the computation of a grid as well as in the computation of one or more grid constants forming the basis of the code.

Thus for the code recognition, in particular one can envisage a grid or a grid constant of the code being determined by approximation, in particular by way of so-called fitting, in order to carry out a scaling of the recorded code inasmuch as this is concerned. The quality of the code, which is determined on the picture level, can also be used for this scaling, but also for the positioning of a grid. The decoding of the code itself can be effected or simplified by way of the quality recognition, too. Since the code is contained redundantly and several times, for example in each code word, then on the basis of a quality determining of all code words, it is those words, which amongst all code words have the highest quality or highest assessment which are selected for decoding the code. Decoding errors can be minimised to a high degree in this way and manner.

Should the decoding on the basis of those words with the highest quality assessment not be possible or not provide a plausible result, one then envisages changing the grid constant and/or the grid position and carrying out the assessment and decoding afresh.

According to a further embodiment, one further envisages the capsules including at least one second optically readable code on the base of the capsule beaker, additionally to the first optically readable code. As already is the case with the first code, the second visually recognisable code also includes a two-dimensional arrangement of several second code elements, which with respect to a middle point of the first code lie radially outside the first code. In particular, with regard to the first code, one envisages it extending over the middle point of the base of the capsule beaker. The middle point of the first code can thereby roughly coincide with a geometric middle point of the base of the capsule beaker.

The first and the second code thereby represent different code levels. The code that is deposited on the capsule base in particular can be designed in a two-staged or multi-staged manner, wherein the first code defines a first code stage or a first code level, and wherein the second code defines a second code stage or a second code level.

If one considers the, for example, four different possible alignments of the code, which is to say of the capsule within the brewing machine, then the middle point of the first code in particular can coincide with a rotation axis of the capsule beaker, with respect to which axis an alignment of the capsule can be brought into another conceivable alignment within the brewing machine.

More and different information can be stored in a coded manner to a differently robust extent on the base of the capsule beaker and read out, in a graduated manner due to the provision of a second code with second code elements. The second code in particular can be optionally provided and contain optional information, which is possibly not of any significance with regard to the operation or the brewing procedure of the brewing machine or is only of a lesser significance. In particular, it is conceivable for brewing parameters or information relevant to the brewing procedure such as, for example, a water quantity, water temperature, pre-brewing time, or a set-point or set-point curve for the pump power, the flow or a pressure to be contained in the first code.

Alternatively, the first code can also merely contain information that permits the identification of the capsule or capsule type and, for example, permits a brewing program or drinks recipe stored in the machine to be assigned to it. A drinks recipe can thereby include additional recipe information that goes beyond the brewing parameters, such as e.g. a quantity and/or temperature of milk or milk froth that is to be added to the brewed drink.

The second code can e.g. include such additional recipe information, or information such as, for example, a sell-by date, a location of manufacture or origin, a manufacturing date or also a batch number.

The arrangement of the first and of the second code in a manner spatially separated from one another permits a selective reading-out of the first and second codes. The spatially separated arrangement of different codes, which is graduated radially outwards, can moreover be used for different brewing machines. The second code can be used or ignored, depending on the design of the brewing machine. Optional additional information concerning the capsule and its extraction material can be rendered accessible, for example, via the second code only to a certain type or design variant of brewing machines having an accordingly high-performance detection unit.

In contrast, it can be sufficient to only read out the first code for inexpensive brewing machines. Inasmuch as this is concerned, such machines can also be provided with an accordingly minimised detection unit and picture evaluation, which merely visually detect or decode the first code located in the central region of the base of the capsule beaker.

According to a further embodiment, the first and the second code elements of the first and second code are essentially identical. The first code elements however are thereby aligned differently compared to the second code elements. For example, the first code elements can be aligned relative to the second code elements in a manner rotated by 90°, by 180° or by 270° in the plane of the base of the capsule beaker. Here too, all first code elements are advantageously identical and identically aligned to one another. The same can also apply to the second code elements of the second code.

Moreover, all of the previously described characteristics and features of the first code elements can be identical or essentially identical to those of the second code elements or also correspondingly realised for the second code elements.

According to a further aspect, the invention moreover relates to a system for preparing a drink from a previously described capsule. The system includes a brewing machine with a brewing chamber for receiving a capsule of the above mentioned type, the capsule having an essentially square base, for the purpose of preparing a brewed drink, as well as with an optical detection unit for reading out a first code from the base of the capsule beaker whilst the capsule is located in a read position above the brewing chamber. The capsule can be positioned in the read position in four different alignments. Thereby, the detection unit is designed in a manner such that it recognises the alignment of individual code elements on the base of the capsule beaker and derives the alignment of the code from this. In this way and manner, the alignment of the code can be effected purely on the basis of the visual recognition of a single code element—or of a few less code elements—without requiring an analysis of the complete code. Only a comparatively low computation capability of a picture evaluation is hence necessary for determining the alignment of the code. At least one corresponding capsule with a square base carrying the code also belongs to the system, wherein the code includes the code elements, from which the detection unit derives the alignment of the code.

Here, one does not rule out the detection unit, additionally to the mentioned (first) code elements, recognising further elements on the capsule base, from which further elements the detection unit although not being able to derive the alignment of the code, however can recognise them as elements of the code, by way of which information can be read out and/or as elements which are rejected as not belonging to the code.

In particular, part-regions of the capsule base can be rejected as not belonging to the code, and such regions, for example, can be arranged peripherally or also within outer edges of the valid code.

According to a further aspect, the invention moreover relates to a method for identifying a capsule with a capsule beaker which has an essentially square base and with a code with a two-dimensional arrangement of several code elements on the base, in a brewing machine for preparing a drink. The method hereby includes the following steps:
transferring the capsule inserted into the brewing machine by the user, into a read position,
recognising code elements and determining the alignment of the code on the basis of the alignment of the code elements,
decoding the code and identifying the capsule type on the basis of the code information contained in the code.

The code information, after successful recognition of the code, can be used for the control of the brewing machine, in particular of a brewing procedure.

It is generally the case that all features and advantages, which are described in the context of the capsule apply to the same extent to the system and to the method described here, and vice-versa.

The term essentially identical or essentially identically aligned code elements, which is demanded in embodiments of the invention, is to express the fact that the code elements within the scope of the resolution accuracy of the detection unit and the subsequently connected picture evaluation are provided on the capsule base in a respectively identical and identically aligned manner. The detection unit and subsequently connected picture evaluation can provide a certain error tolerance, so that even slight, but also larger deviations from a defined geometry, position and/or defined alignment of the code elements can still be reliably detected.

Geometric deviations of the code elements with regard to their longitudinal or transverse extension of up to 10% or up to 20%, up to 30% or even up to 40% should hereby still fall within the tolerance region of the detection unit and thus still be valid as being essentially identical. In contrast, line or stripe thicknesses can differ from a predefined thickness by up to 200%. With regard to the alignment, deviations of 5%, up to 20°, 30° or even 35% can be tolerated which is to say can be compensated by the detection unit and the subsequently connected picture evaluation.

### BRIEF DESCRIPTION OF THE DRAWINGS

Embodiment examples of the invention are hereinafter described by way of figures. In the figures, the same reference numerals indicate the same or analogous elements. There are shown in:

FIG. 1 is a perspective view of a capsule for drinks preparation,

FIG. 2 is a lateral view of the capsule according FIG. 1,

FIG. 3 is a schematic representation of a brewing machine, which is designed for receiving a capsule,

FIG. 4 is a schematic and simplified representation of a detection unit, which is provided in the machine and is for visually detecting the code on the base of the capsule beaker,

FIG. 5 is a schematic representation of a first code, which is provided on the base of the capsule beaker,

FIG. 6 is a simplified and schematic representation of a regular subdivision of the first code into individual code fields, code groups and code words,

FIG. 7 shows different positions of a code element in different code fields of a code group,

FIG. 8 is a simplified schematic representation of a base of the capsule beaker with a first and with a second code and

FIG. 9 is a schematic representation of two different code elements.

### DETAILED DESCRIPTION OF THE INVENTION

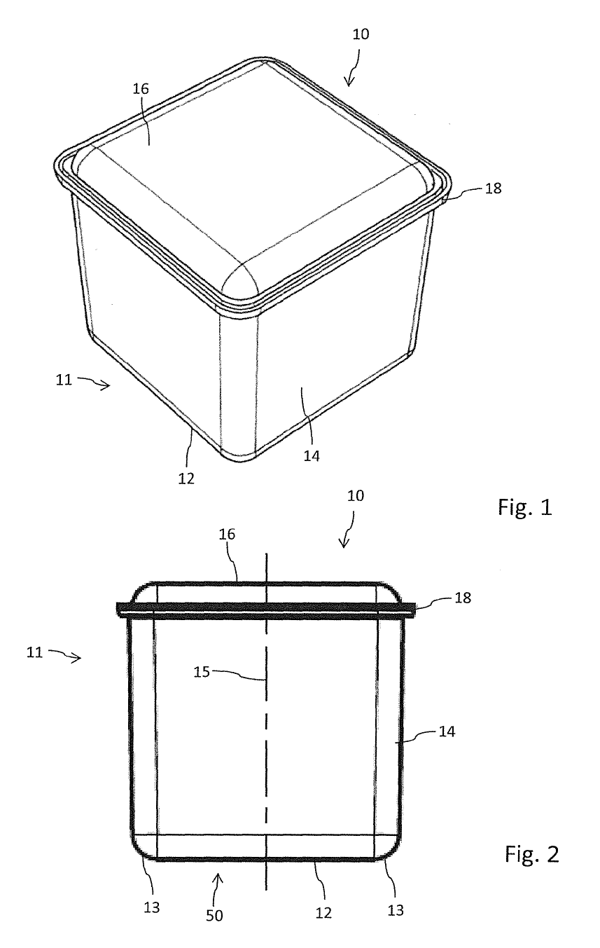

The capsule 10, which is represented in FIGS. 1 and 2, includes a pot-like capsule beaker 11 with a square capsule base 12. The capsule beaker 11 is away from the base 12 closed with a capsule cover 16 extending over the complete cross section of the capsule beaker 11. The capsule cover 16 and the side walls 14 of the capsule beaker 11 form an outwardly projecting flange section 18. The peripheral flange section 18, apart from a closure function, also serves for guiding and aligning the capsule. A receiver 21, which is provided on a brewing machine 20 and is typically in the form of an insertion or receiving shaft, can have a geometry corresponding to the outer contour of the capsule 10, which is represented in a lateral view in FIG. 2, so that the capsule can be introduced into the receiver of the brewing machine 20, compellingly in an orientation or alignment, in which the base 12 of the capsule beaker faces a detection unit 24.

Given a correct positioning of the capsule 10 in a read position L within the brewing machine 20, there are still four different possible orientations of the capsule 10 and of the optically readable or visually recognisable code 50 provided on the base 12, due to the square geometry of the base 12 of the capsule beaker 11 and of the essentially square, peripheral flange section. The different and several possible alignments of the code 50 are due to rotations of the capsule with respect to its imagined rotation axis 15, which extends essentially perpendicularly to the base 12 and perpendicularly to the capsule cover 16, and which in particular can coincide with a geometrical middle point of the base 12 and capsule cover 16.

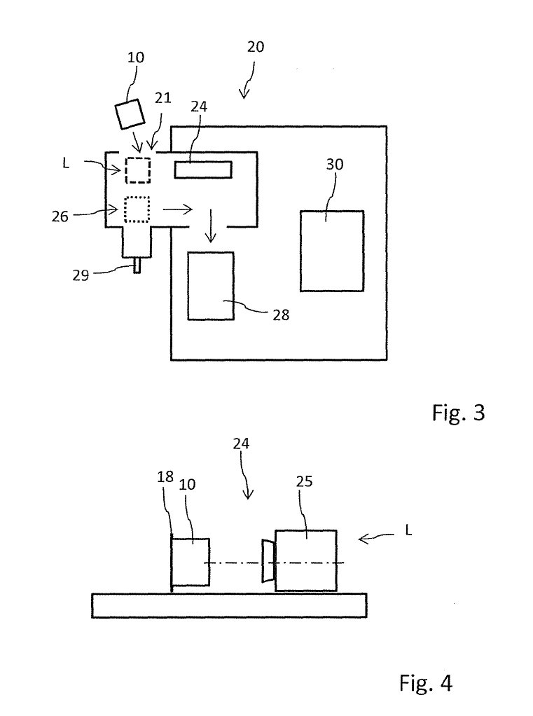

The brewing machine 20, which is shown in FIG. 3 is envisaged for receiving at least one capsule 10 which, by way of insertion into the receiver 21, can firstly be held in a read position L. In this read position L, the code 50 provided on the outer side of the base 12 of the capsule beaker 11 can be visually detected by way of the detection unit 24 and fed to a picture evaluation, by way of which picture evaluation the coded information can be decoded. A brewing chamber 26, in which the capsule 10 filled with the extraction product is pierced and the extraction material can be brought into contact with a fluid envisaged for the extraction procedure, in particular hot water, is located after the read position L. The extract, which is to say the drink, prepared in this way and manner can subsequently be collected via an outlet 29, in a drinks vessel, which is not explicitly shown. The spent capsule 10 can then be fed to a capture container 28 after the brewing procedure, and this container needs to be emptied now and again.

The brewing machine 20 is moreover provided with a control 30, which amongst others is coupled to the detection unit 24. A picture evaluation can either be contained in the detection unit 24 or in the control 30. The brewing procedure can be controlled, however at the minimum can be influenced, by reading out the code information of the capsule 10. The code 50, for example, can contain information concerning a preset brewing program, which can be automatically selected by the control 30 after the recognition and reading-out of the code 50. The operating comfort of the brewing machine 20 can be increased and improved in this manner.

The brewing machine can moreover be provided with a motor, which is not represented in FIG. 3 and which opens and closes the brewing chamber. This motor can likewise be controlled by the control, so that the capsule is automatically be transferred into the brewing chamber 26 after a successful recognition and reading out of the code. The operating comfort for the user is increased by way of this.

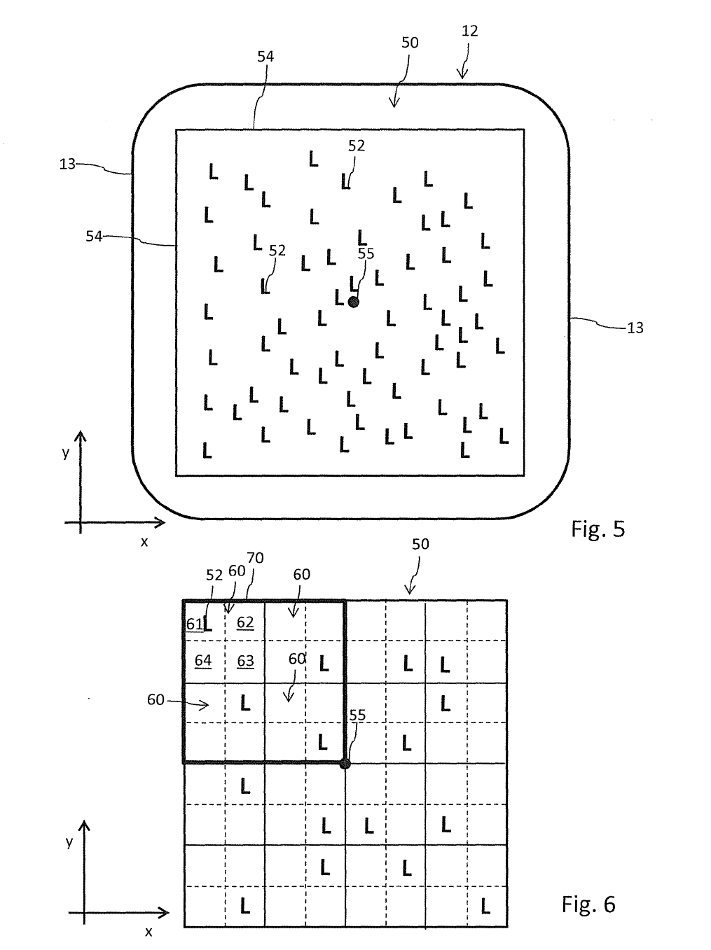

The detection unit 24 is represented in a simplified manner in the schematic representation according to FIG. 4. The detection unit 24 in particular includes a camera 25, which with its optical axis typically essentially coincides roughly with the middle point 55 of a first code 50 shown in FIGS. 5 and 6, as soon as the capsule 10 is located within the brewing machine 20 in the read position L. A first code 50 on the base 12 of the capsule beaker 11 is represented schematically in FIG. 5. The first code 50 has an at least imagined middle point 55, which lies centrically or centrally within the outer edges 54 of the first code 50.

The first code 50 moreover includes a two-dimensional arrangement of several first code elements 52. Each of the first code elements 52 contains information, from which one of several possible alignments of the code 50 in the plane of the base 12 is unambiguously derivable. The code 50 can be arranged in total in four different alignments in the X-Y plane, which is represented in FIGS. 5 and 6 and which, for example, represents the picture plane of the detection unit 24 or coincides with this. The individual alignments can be assumed, for example, by way of a rotation of the capsule 10 in each case by 90° with respect to its rotation axis 15. The rotation axis 15 of the capsule beaker 11 can thereby coincide with the imagined middle point 55 of the first code 50.

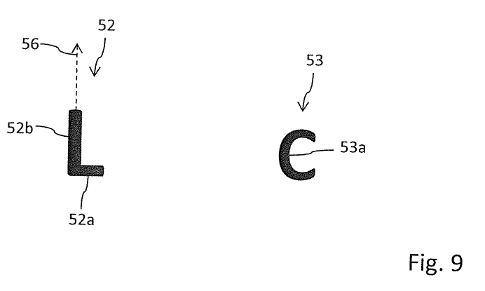

What can be recognised is that all first code elements 52 of the first code 50 are designed in an identical or essentially identical manner. They have an L-shaped contour with a first line section 52a, which extends horizontally in FIG. 5 and FIG. 9 and with a second, essentially vertically aligned line section 52b. With the alignment of the code 50 and of its individual code elements 52, which is represented in FIGS. 5 and 9, the intersection point of the line sections 52a, 52b lies at the bottom left. A short limb or the first line section 52a extends horizontally to the right from the intersection point, whereas the longer, i.e. the second line section 52b extends vertically upwards from the intersection point of the line sections 52a, 52b.

This arrangement and alignment of the individual line sections 52a 52b renders possible an unambiguous determining of the alignment of the associated code element 52 and of the code 50, which is formed by this. In particular, a pointer structure 56 can be unambiguously assigned to the code element 52. Here, for example, a pointer structure 56 in the extension of the second line section 52b is shown in FIG. 9, wherein the pointer structure 56 points away from the intersection point of the two line sections 52a, 52b. On rotating the code 50 and its code elements 52, for example by 90° in the clockwise direction, a corresponding rotation of the line sections 52a, 52b as well of the associated pointer structure 56 results. This would then point horizontally to the right. The alignment or the orientation of the code 50 in the plane of the base 12, between the several possible alignments, can be determined comparatively simply as well as with a reduced effort concerning software and hardware technology by way of determining the alignment of a single arbitrary code element 52, due to the fact that all code elements 52 are aligned essentially identically to one another and by way of the orientation of the code elements 52 being fixedly linked to the orientation of the code 50.

Hereby, it is particularly advantageous if at least one line section 52a, 52b of the first code elements 52 runs essentially parallel to the outer edges 13 of the square base 12 and/or essentially parallel to the outer edges 54 of the essentially rectangular or square code 50. Moreover, a right-angled arrangement of the differently long line sections 52a, 52b has been found to be advantageous for a particularly robust and precise position recognition of the code elements 52. The detection unit 24 in particular can include a regular, two-dimensional arrangement of several detector pixels, which can be arranged horizontally next to one another and vertically below one another, corresponding to the X-Y plane. Even with a low resolution of the detection unit or even with imaging errors, a picture recognition which is adequate for determining the alignment of the code 50 can still be provided due to the fact that the line sections 52a, 52b of the first code elements 52 are either aligned vertically or horizontally with respect to the X-axis and Y-axis respectively.

The use of L-shaped code elements 52 is only described by way of example and does not necessarily need to be provided. Basically, it is also conceivable to use other code elements 53, for example with a C-shaped basic geometry and with an arch section 53a, as is shown in FIG. 9. U-shaped, V-shaped or T-shaped code elements or code elements in the form of asymmetrical surface areas are conceivable to the same extent. The only requirement concerning the code elements is that they inherently define a clear and unambiguous orientation in the plane.

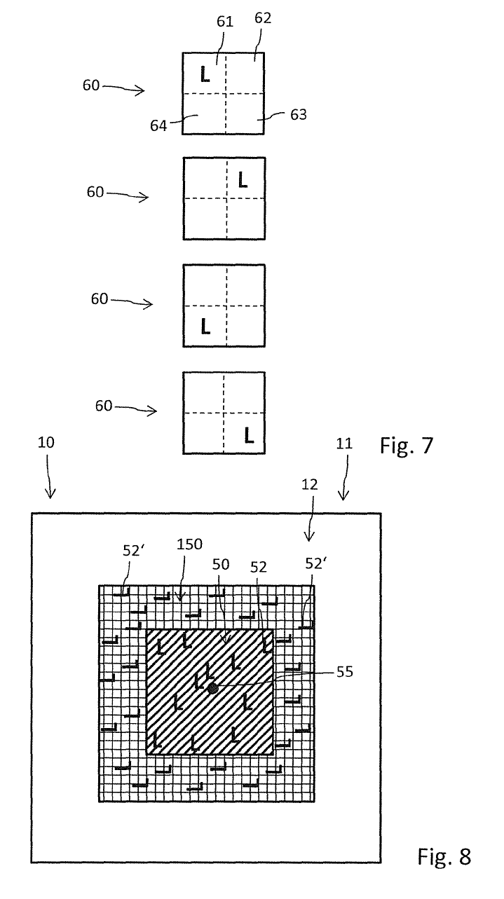

In FIG. 6 it is represented schematically as to how the first code 50 is subdivided into a regular imagined arrangement of code fields 61, 62, 63, 64, which at least in pairs are grouped into code groups 60. Hereby, only a single code field 61, 62, 63, 64 within a code group 60 is provided with a code element 52, whereas the remaining code fields 61, 62, 63, 64 of a code group 60 remain free of code elements 52. The different conceivable positions of a code element 52 in a code group 60, which is formed from in total four code fields 61, 62, 63, 64, are shown in FIG. 7. The four code groups 60, which are represented in FIG. 7, each represent one of four different conditions. Inasmuch as this is concerned, a code group 60, which is formed from in total four code fields, represents information of in total 2 bits (2²=4).

The rule, according to which each code group 60 is provided with only a single code element 52 has the effect that the surface density of first code elements 52 normalised onto the surface area size of the code groups 60 is constant over the entire surface of the first code 50. Moreover, each arbitrary surface segment of the first code 50, which has an integer number of code groups, has an identical density of information. Finally, the local position of a code element within the code group is a carrier of the information concerned. The code information can be stored in the code by way of a single type of identical code elements 52, due to the fact that the code information is contained in the position of the individual code elements 52 relative to the code groups 60 or relative to the outer edge 54 of the code 50.

Moreover, one envisages a code group 60 including at least four code fields 61, 62, 63, 64 and, entailed by this, a minimum information with a 2 bit length. Moreover, several code groups 60 and/or several code fields 61, 62, 63, 64 can be grouped together into a code word 70. With the embodiment shown in FIG. 6, the code groups 60, which are provided in the left upper square of the code 50, are grouped together into a code word 70, which in total includes sixteen code fields 61, 62, 63, 64.

According to the requirement that a code group 60 is permitted to contain or include only a single code element 52, a first integrity test of the code 50 can be effected independently of a decoding of the code 50 and thus already directly on the basis of a recorded picture of the code 50. If, for example, the detection unit 24 recognises that more than one code element 52 is contained in several code fields 60, then the respective code regions can be rejected. The number of code elements 52 within a code word 70 can be examined in the same way and manner.

Moreover, one envisages code information of the code 50 being redundantly contained in several code words 70, for example via a Reed-Solomon coding or another form of redundancy coding. In this way and manner, it can be ensured that the code 50 and the code information contained in this can be read out in a reliable manner in the case of regional contamination in the region of the code 50 or of the detection unit 24. Thereby, in particular it is conceivable for the imaging and read-out quality of individual code words 70 to be determined, for example, by way of assigning and identifying individual code elements 52 to and with individual code words 70. If, for example, a demanded number of code elements 52 for the code word 70 should not be contained in a recorded picture, then this is an indication that the code word 70 concerned has been affected by contamination or is subject to an imaging error. Of the quantity of code words 70, it is typically only those that have a predefined number of code elements 52 that are selected for the decoding.

If not enough complete code words 70 are present for the decoding, then several estimations or assumptions to be considered can be made at the respective locations. Then, in the course of an integrity test of the code information subsequently resulting from the respective assumption and/or of the individual information bits, after decoding it can be decided whether the assumption was correct or not. Accordingly, a different assumption can also be made on the basis of the integrity test. This procedure can be repeated iteratively until the code information resulting from the made assumption fulfils the criteria of the integrity test.

Apart from the grouping of individual code groups 60, which is represented in FIG. 6, a code word 70 can basically also consist, for example, of one or more code groups and additionally of one or more code fields, so that the total number of code fields 61, 62, 63, 64 of a code word 70 is an odd numbered multiple of the number of code fields 61, 62, 63, 64 per code group 60. Hereby, it is conceivable for individual code fields 61, 62, 63, 64 to contain a type of test bit or test code, whereas the code words 70 are the carriers of the actual code information.

In the further embodiment of a capsule 10, according to the representation of FIG. 8, it is conceivable for not only a first code 50, but yet a second code 150 to be provided on the base 12 of the capsule beaker 11, additionally to the first code 50. Whereas the first code 50 with its first code elements 52 is arranged roughly centrally or in a middle region of the base 12, the second code 150 with its second code elements 52′, with respect to the geometrical middle point of the first code 50 is located radially outside the first code 50. In the embodiment according to FIG. 8, the second code 150 completely encloses the first code 50 in the peripheral direction. The first and second code 50, 150 thereby each have a rectangular or square outer contour. In other words, the first code 50 is located within the second code 150.

The codes 50, 150 however are not designed in an overlapping manner. There are solely first code elements 52 belonging to the first code that are located in the region of the inner lying first code 50. The second code elements 52′ can be designed identically to the first code elements 52′. In this case however, one then envisages the first and second code elements 52, 52′ being aligned differently for the unambiguous and improved differentiation of the first and second code 50, 150. Here, all first code elements 52 are aligned in an essentially identical manner, whereas all second code elements 52′ are aligned in an essentially identical manner. In the embodiment example shown in FIG. 8, the orientation of the second code elements 52′ is rotated in the anticlockwise direction by 90° in comparison to the orientation of the first code elements 52.

However, differing from this, it is conceivable, for example, for the second code elements 52′ to have a geometry that is different to the L-shaped contour, for example a C-shaped contour or a U-shaped contour, which as such can be visually differentiated from the contour and geometry of the first code elements 52. For determining the alignment of the first and second code 50, 150, it is basically sufficient if only one of the first and second code elements 52, 52′ contains information from which one of several possible alignments of the code 50, 150 in the plane of the base 12 can be unambiguously derived. Point-like or rotationally symmetrical code elements can basically also be used instead of rotated L-shaped second code elements 52′.

The first and second codes 50, 150 typically contain different code information. The first code 50 typically includes information provided for a brewing procedure, for example with regard to a brewing program, water quantity, brewing temperature, brewing pressure, flow rate, pump power, brewing time or pre-brewing time, whereas the outer lying code 150, which is possibly only optionally to be used for certain brewing machines 20 contains further additional information concerning the extraction material, such as, for example, a sell-by-date, a production location, a location of origin or a batch number.

The different or the differently aligned code elements 52, 52′ permit a visual separation of the first and second code 50, 150, so that these can be detected, read out and decoded separately and independently of one another. The alignment of the second code elements 52′ relative to the outer edges 54 of the first code 50 or of the second code 150 as well as the arrangement of the second code elements 52′ amongst one another, in particular their arrangement in an at least imagined or virtual subdivision into code fields 61, 62, 63, 64, code groups 60 and code words 70 can be designed essentially identically to the first code elements 52. The first code 50 as well as the second code 150 can be recognised, read out and decoded with one and the same picture evaluation in this way and manner.

The redundancy test here is selected in a manner such that the code information can be decoded already with a readability of 10% to 15% of the code surface. The code information is quasi uniformly distributed over the surface of the code 50 by way of the homogenous distribution of code groups 60 and code words 70 over the surface of the code 50. This renders the code 50 particularly robust given regional contamination or imaging errors

An integrity and plausibility test of code words 70 can be achieved directly on the bit level and on picture level due to the predefined constraint that a code group 60 formed from code fields 61, 62, 63, 64 includes exactly one code element 52. Moreover, a constant write time for the code 50 on the base 12 of the capsule beaker 11 can be achieved by the homogeneous distribution of the code elements within code groups. This can be achieved by a writing device, which has a writing time that is proportional to the surface to be written. The writing device can be designed as a galvo laser scanner for example. On writing or inscribing the base 12 by way of laser for instance, it is always the same number of code elements 52 that are written per unit of time.

It is even conceivable to carry out an integrity test of the code 50 or of the code words 70 or code groups 60, which are contained in the code 50, purely on the picture level. The better the integrity test is effected on the picture level, the less test bits are to be added to the code words 70. It is even conceivable to carry out an integrity test of the code 50 completely on the picture level, so that one can largely make do without test bits within the code 50.

### LIST OF REFERENCE NUMERALS

10 capsule
11 capsule beaker
12 base
13 outer edge
14 side wall
15 rotation axis
16 capsule cover
18 flange section
20 brewing machine
21 receiver
22 brewing unit
24 detection unit
25 camera
26 brewing chamber
28 capture container
29 outlet
30 control
50 code
52 code element
52′ code element
52a line section
52b line section
53 code element
53a arch section
54 outer edge
55 middle point
56 pointer structure
60 code group
61 code field
62 code field
63 code field
64 code field
70 code word
150 code

1. A capsule for drinks preparation in a brewing machine, wherein the capsule comprises a capsule beaker that is filled with an extraction material and has an essentially square base, and a capsule cover closing the capsule beaker, said capsule having at least one first optically readable code on the base of the capsule beaker, said code comprising a two-dimensional arrangement of several first code elements, which each comprise information, from which one of several possible alignments of the code in the plane of the base can be unambiguously derived.

2. The capsule according to claim 1, wherein the first code comprises a number of essentially identical and essentially identically aligned first code elements.

3. The capsule according to claim 1, wherein the first code elements comprise at least two straight line sections, which are adjacent to one another at a predefined angle.

4. The capsule according to claim 3, wherein at least one line section of the first code elements runs essentially parallel to the outer edges of the essentially rectangular or square code.

5. The capsule according to claim 3, wherein at least one line section of the first code elements runs essentially parallel to the outer edges of the square base.

6. The capsule according to claim 1, wherein the first code elements are essentially L-shaped.

7. The capsule according to claim 1, wherein the first code elements comprise at least one arch section.

8. The capsule according to claim 1, wherein the code elements are lasered onto the base of the capsule beaker or into the base.

9. The capsule according to claim 1, wherein the first code comprises 50-400 code elements.

10. The capsule according to claim 1, wherein the first code is subdivided into a regular, imagined arrangement of code fields, which at least in pairs are grouped into code groups, wherein only a single code field within a code group is provided with a code element.

11. The capsule according to claim 9, wherein the local position of a code element within the code group comprises information.

12. The capsule according to claim 1, wherein at least one second optically readable code on the base of the capsule beaker, said second optically readable code comprising a two-dimensional arrangement of several second code elements, which lie radially outside the first code with respect to a middle point of the first code.

13. The capsule according to claim 12, wherein the first code elements and the second code elements are essentially identical and the first code elements are aligned differently compared to the second code elements.

14. A system for preparing a drink from a capsule according to any one of the preceding claims, comprising:
a brewing machine comprising:
a brewing chamber for receiving a capsule with a capsule beaker with an essentially square base,
an optical detection unit for reading out a code with a two-dimensional arrangement of several code elements on the base while the capsule is located in a read position above the brewing chamber,
wherein four different alignments of the capsule are possible in the read position and the detection unit is designed in a manner such that it recognises the alignment of the code elements and derives the alignment of the code from this,
wherein the system further comprises a capsule with a square base carrying the code, wherein the code comprises the code elements from which elements the detection unit derives the alignment of the code.

15. A method for identifying a capsule with a capsule beaker with an essentially square base and with a code with a two-dimensional arrangement of several code elements on the base, in a brewing machine for preparing a drink, the method comprising the steps of:
transferring the capsule inserted into the brewing machine by the user, into a read position,
recognising code elements and determining the alignment of the code on the basis of the alignment of the code elements,
decoding the code and identifying the capsule type on the basis of the information contained in the code.
